(19) United States
(12) Patent Application Publication
(10) Pub. No.: US 2004/0250580 A1
(43) Pub. Date: Dec. 16, 2004

(54) Method for manufacturing organic fertilizer with ingredient made from organic wastes and device therefor

(75) Inventor: Kenichiro Majima, Niigata-ken (JP)

Correspondence Address: AKERMAN SENTERFITT, P.O. BOX 3188, WEST PALM BEACH, FL, 33402-3188, US

(73) Assignee: K-Con Kabushiki Kaisha, Niigata-shi (JP)

(21) Appl. No.: 10/726,720

(22) Filed: Dec. 3, 2003

(30) Foreign Application Priority Data
Oct. 28, 2003 (JP) 2003-366933
Mar. 20, 2003 (JP) 2003-077137

(51) Int. Cl. C05F 11/08

(52) U.S. Cl. 71/10

(57) ABSTRACT

A method for manufacturing an organic fertilizer using organic wastes such as domestic animal's excrements as a raw material. The method enables the manufacture of a fertilizer without emitting any bad smell and is able to obtain stable composition in a short time and at low cost, using a simple device. A device for the method also is provided. The method includes a boiling step for boiling organic wastes, a drying step for drying the boiled organic wastes, and a roasting step for roasting the dried organic wastes. The device for the method includes a device body 10 for boiling, drying and roasting organic wastes, a material supply unit 20 for supplying the device body 10 with the organic wastes, and a deodorizing unit 40 for removing bad smell emitted from the device body, and a product discharge unit 30.

### BACKGROUND OF THE INVENTION

1. Field of the Invention

This invention relates to a method for manufacturing an organic fertilizer with its ingredients made from organic wastes and a device therefor.

2. Description of the Prior Art

Conventional methods of manufacturing organic fertilizers or manures, using domestic animals' (i.e., livestock's) excrements as raw materials have generally been composting in which microorganisms are utilized to decompose organic components thereof. However, such conventional methods have had a problem that a large-sized fermentation device would be necessary in order to make composts fully matured, thus consuming a long processing time ranging from one month to six moths or longer, and thus the manufacturing efficiency has been extremely inferior, resulting in high manufacturing costs.

Moreover, traditional composts manufactured by using domestic animals' excrements as raw materials are often disliked by farmers because they emit extremely bad smell, having such unstable qualities that they contain not only a varying range of moisture content varying from about 15% to 40% depending on a fertilizer manufacturing factory therefor but also varying manure compositions, which are susceptible to change under the influence of the moisture content when the composts are being stored, eventually causing disturbance of growth to farm products if they are not fully matured. As a result, the amount of use of the composts has been decreased nationwide in Japan, and thus most of the excrements of domestic animals which are normally used only for composts have been either incinerated or left untreated in the past.

In addition, composts contain such a lot of moisture content ranging from about 15 to about 40%, growing fungus or generating gases, and thus their qualities are too unstable to be stored for a long period, so that the mechanical dispersion of composts could not be performed together with that of chemical fertilizers. Specifically, whilst chicken manure generally contains a composition equivalent to that of commercial fertilizer, yet it could not be used as a material of such commercial fertilizer for general use.

If it is possible to manufacture such an organic fertilizer that has a stable quality and is easy to handle, using domestic animals' excrements as raw materials at low costs, then it is expected that such manufacturing method will be able to make contributions to the revitalization of deteriorated soils resulting from the continuous use of chemical fertilizers and eventually to the production of good quality farm products, through the effective utilization of domestic animals' excrements that are often produced too much to dispose completely.

One of conventional methods for producing compost in a short period by processing garbage or the like is disclosed in Japanese registered patent publication No.3294207. According to the method, garbage is subjected to a low temperature carbonization process by heating the same at temperature ranging from 100 degrees centigrade to 250 degrees centigrade under a reduced pressure. Although the publication describes that the method makes it possible to convert the garbage into compost in a short time, it has turned out that such simple low temperature carbonization processing, consisting only of rapid drying and heating by feeding a hot air under a reduced pressure, can not produce as good a compost as comparable to fully matured one, but produces something like simply carbonized or dried dung. Further, germination test and growth test preformed on substances produced by this method have revealed that the resultant substances cause low germination rates and growth disorders.

### SUMMARY OF THE INVENTION

It is, therefore, an object of the present invention to provide a method for manufacturing an organic fertilizer using organic wastes such as domestic animal's excrements as a raw material, which enables the manufacture of a fertilizer that emits no bad smell and is able to obtain stable composition in a short time and at low cost, using a simple device.

It is another object of the invention to provide a device for manufacturing such organic fertilizer.

To attain the above objects, the inventor of the present invention has been dedicated to developing such organic fertilizer, and finally found it out that it is possible to obtain such organic fertilizer by subjecting domestic animals' excrements to boiling, drying and roasting processes in sequence for certain preset hours.

According to a first aspect of the invention, there is provided a method for manufacturing an organic fertilizer using organic wastes as a raw material, which comprises the steps of: boiling the organic wastes; drying the boiled organic wastes; and then roasting the dried organic wastes.

Thus, it is possible to manufacture an organic fertilizer with stable and desirable composition comparable to that of excellent compost, which emits no bad smell and is obtained in a short time and at low cost, using organic wastes as a material by a simple device.

According to a second aspect of the invention, there is provided a method for manufacturing an organic fertilizer set forth in the first aspect, in which the organic wastes- are boiled for preset hours so as to decompose organic components thereof in the boiling step.

Thus, it is possible to manufacture an organic fertilizer that emits no bad smell, with stable and excellent composition, obtained in a short time and at low cost, using organic wastes as a material, by a simple device.

According to a third aspect of the invention, there is provided a method for manufacturing an organic fertilizer set forth in the first aspect, in which the dried organic wastes are roasted for preset hours so as to decompose smelly components thereof in the roasting step.

Thus, it is possible to manufacture an organic fertilizer that emits no bad smell, with stable and excellent composition, such organic fertilizer being obtained in a short time and at low cost, using organic wastes as a material, by a simple device.

According to a further aspect of the invention, there is provided a device for manufacturing an organic fertilizer using organic wastes as a raw material, including: a device body for boiling, drying and roasting organic wastes; a material supply unit for supplying the device body with the organic wastes; and a product discharge unit for discharging final products from the device body.

Thus, it is possible to provide a device which enables the manufacture of an organic fertilizer emitting no bad smell, with stable and excellent composition, in a short time and at low cost, using organic wastes as a material.

### BRIEF DESCRIPTION OF THE DRAWINGS

For more complete understanding of the present invention, reference is now made to the following description taken in conjunction with the accompanying drawing, in which:

FIG. 1 is a cross-sectional view illustrating a device for manufacturing an organic fertilizer with ingredient made from organic wastes in accordance with an embodiment of the invention.

FIG. 2 is a side view illustrating the device of FIG. 1

FIG. 3 is a flow chart of the device of FIG. 1.

FIG. 4 is a schematic view illustrating the device of FIG. 1.

FIG. 5 is a graph showing change in temperature and moisture content of a material and temperature of thermal oil, with time.

### DETAILED DESCRIPTION OF PREFERRED EMBODIMENTS

Hereinafter are described in full detail a method for manufacturing organic fertilizer using organic wastes as raw material, and a device therefor.

A first embodiment is described with reference to attached drawings.

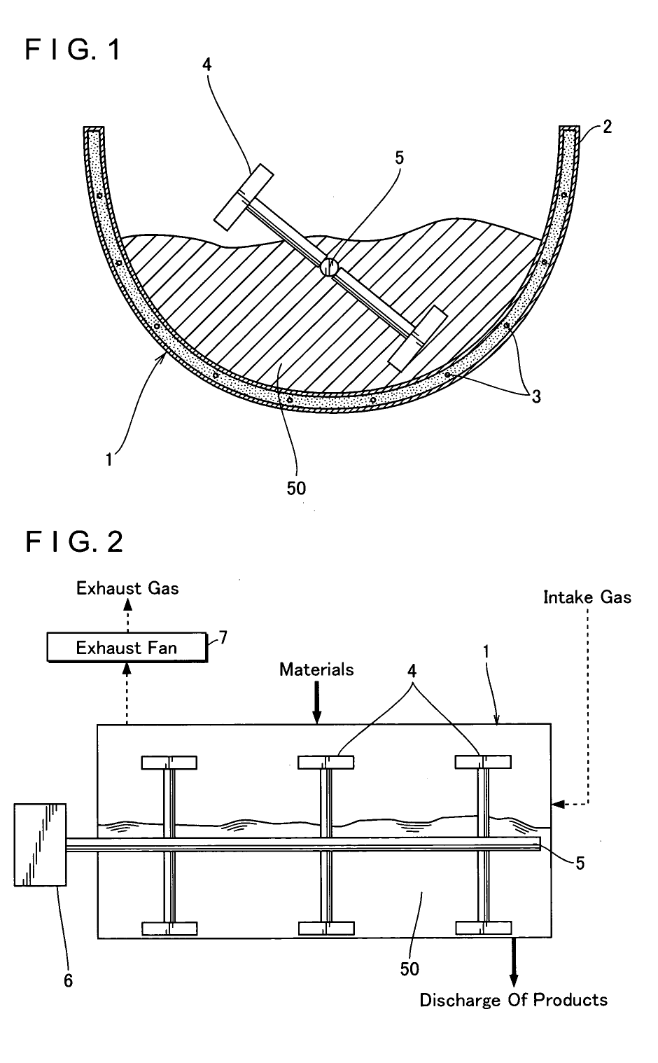

In FIGS. 1 and 2 showing a device body 10, reference numeral 1 designates a treatment tank, around which is provided a jacket 2 for circulating thermal oil which is for heating the treatment tank 1. The jacket 2 is provided thereinside with a thermal oil heater 3 for heating the thermal oil such that the thermal oil heated by the thermal oil heater 3 is circulated in the jacket 2 to thereby uniformly heat a material 50 that are organic wastes accommodated into the treatment tank 1.

Inside the treatment tank 1 is provided at least one stirring blade 4 supported by a shaft 5, while outside the treatment tank 1 is provided a motor 6 for rotationally driving the stirring blade 4. It should be noted that the stirring blade 4 is formed to have a specialized structure, in order to prevent the material 50 from sticking on to the wall surface of the treatment tank 1.

Reference numeral 7 designates an exhaust fan for drawing and discharging water vapor or exhaust gas generated from the treatment tank 1 to the outside of the device body 10. Then, the stirring blade 4 is rotated in a forward direction to stir the material 50, while it is rotated in a reverse direction to discharge the processed products.

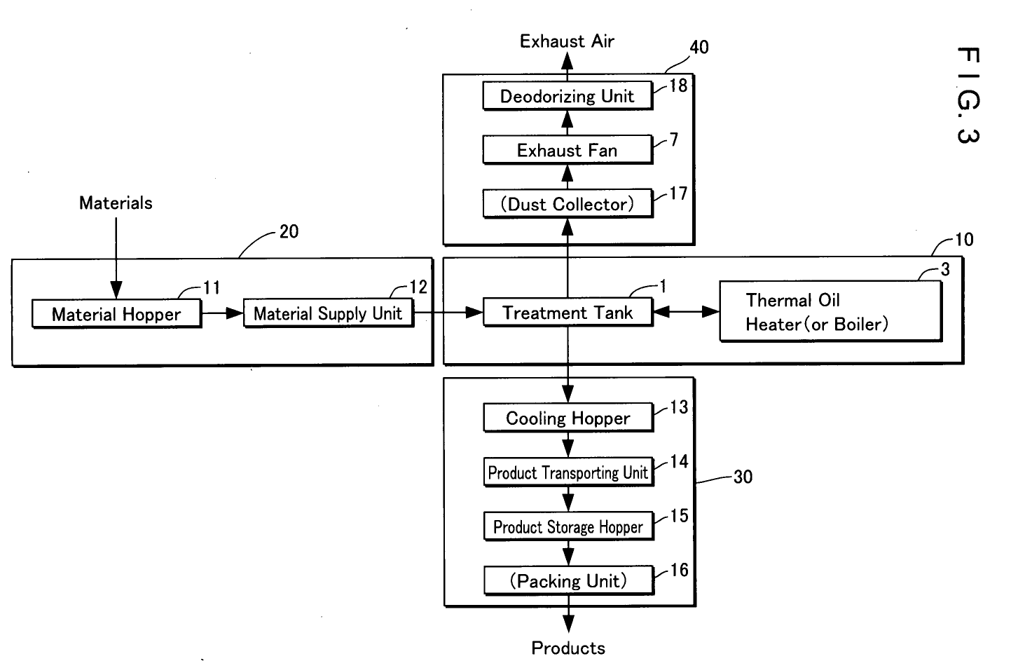

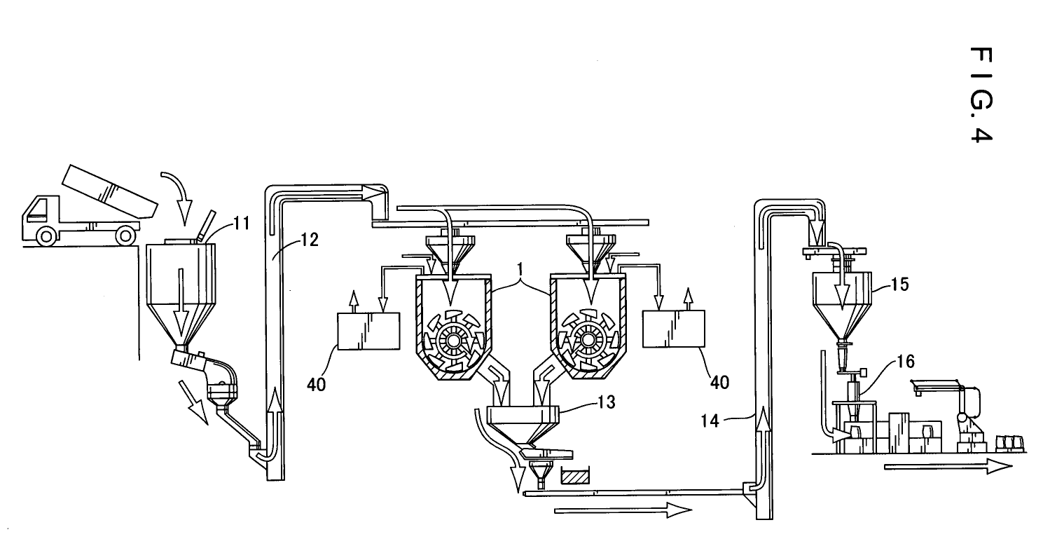

In FIG. 3 showing an overall flow of the device of the invention and FIG. 4 showing a schematic view thereof, reference numeral 20 designates a material supply means for supplying the device body with the material 50. The material supply means 20 includes a material hopper 11 for temporarily storing the material 50 and a material supply unit 12 for supplying the treatment tank 1 with the material 50.

Reference numeral 30 designates a product discharging means for discharging products from the device body 10. The product discharging means 30 includes a cooling hopper 13 for forcedly cooling the products which were just processed and discharged from the treatment tank 1, a product transporting unit 14 for transporting the products cooled in the cooling hopper 13 and a product storage hopper 15 for storing the products transported by the product transporting unit 14. If necessary, the product discharging means 30 may further include a packing unit 16 and a measuring unit (not shown), but the product packing unit 16 may be omitted if the products do not need packing.

Reference numeral 40 designates a deodorizing means for getting rid of odor or bad smell contained in water Vapor or exhaust gas generated from the device body 10. The deodorizing means 40 includes the aforesaid exhaust fan 7 for drawing and discharging water vapor or exhaust gas generated from the device body 10 to the outside and an deodorizing unit 18 for getting rid of odor or bad smell contained in the water vapor or exhaust gas which was drawn and discharged by the exhaust fan 7. The deodorizing unit 18 is of a direct-fired system such that odor emitting elements are burnt to be deodorized. It should be noted, however, that the structure of the deodorizing unit 18 is not limited thereto. In addition, a wet type dust collector 17 or the like may be provided in a preceding stage of the exhaust fan 7 where necessary.

Next is a description of a method for manufacturing an organic fertilizer with its ingredients made from organic wastes, using the above-mentioned device.

The most preferable organic wastes used for the present invention are domestic animals' excrements which contain much moisture content and emit extremely bad smell. However, any other organic wastes may be used suitably as long as they contain sufficient amount of moisture content, such as organic sludge or biomass residues. If the percentage of the moisture content is too high, however, it will take too long a time for the moisture content to evaporate, and thus the percentage of the moisture content should be 85% or below, If the moisture content exceeds 85%, then suitable adjuster substances such as rice chaff, sawdust, the products manufactured according to the present invention in previous operations or the like may be added to thereby adjust the moisture content to 85% or below.

Initially, the material 50 composed of organic wastes such as domestic animals' excrements are put into the material hopper 11. Then, the thermal oil heater 3 is energized to start heating the jacket 2 of the treatment tank 1, while the dust collector 17, the exhaust fan 7 and the deodorizing unit 18 are actuated. Alternatively, the thermal oil may be heated directly, using a boiler instead of the thermal oil heater 3. Next, the material supply unit 12 is actuated to supply the treatment tank 1 with a predetermined amount of the material 50 in the material hopper 11, and starts stirring the material 50 by the rotation of the stirring blade 4 in the forward direction.

In a boiling process, the material 50 is subjected to a heating process while being stirred by the stirring blade 4 such that the thermal oil is heated to a preset heating temperature of from 200 to 220 degrees centigrade. Due to a large amount of moisture content being contained in the material 50, its temperature will not reach 100 degrees centigrade.

Thus way, heating process and stirring operation are continued to thereby boil the material 50. Through this boiling process, bacteria such as microbes or viruses contained in the material 50 are killed, and harmful seeds and the like are decomposed. Further, perishable biological components such as protein and the like are decomposed so that the composition of the material 50 is stabilized. It should be noted herein that the boiling hours may be preferably five hours or above, since the boiling hours less than five hours will result in lowered product quality and thus it is not desirable. Furthermore, by allowing the thermal oil heated by the thermal oil heater 3 or the boiler to be circulated in the jacket 2, the material 50 accommodated in the treatment tank 1 is heated uniformly, thereby improving the heating efficiencies, enabling the products to be finished to a constant quality.

After carrying out the boiling process for five hours or above, the material 50 is then allowed to advance into a drying process while being heated under the same condition. The moisture content of the material 50 is gradually evaporated in this drying process. As the evaporation of the material 50 proceeds, the temperature of the material 50 rises gradually. When the temperature of the material 50 becomes higher than 100 degrees centigrade, smelly components and easily decomposable organic matter are volatilized or decomposed so that the temperature of the material 50 reaches 160 to 170 degrees centigrade. At this stage, the drying process may be accelerated by blowing or drawing hot air into the treatment tank 1 so that the moisture content may be efficiently evaporated.

When the moisture content of the material 50 approaches zero %, then it advances into a roasting process. In this roasting process, heating and stirring are continued under the same condition as the preceding boiling process, and the roasting process of at least three hours allows the smelly components to be substantially decomposed and thus removed. Specifically, by carrying out the roasting process for at least three hours after the temperature of the material 50 reaches 160 to 170 degrees centigrade, there can be obtained high quality products of which the composition being comparable to that of fully matured compost, emitting no bad smell. Also by this roasting process, cellulose or fibers, as ingredients of the material 50, also are decomposed simultaneously, while the material 50 is changed into fine particles by the stirring blade 4.

Preferable hours for the temperature of the material 50 to reach 160 to 170 degrees centigrade through the boiling and the drying process may be set at about 16 hours, thereby making it possible to take out final products within 24 hours after the material 50 is introduced. As a result, running costs including labor costs can be reduced substantially. Specifically, in the case of batch processing like in the present embodiment, operating pattern can be provided in such a manner that final product is taken out on the day after introducing the material, and then a new material is introduced thereafter, thereby enabling the improvement of producing efficiency. It should be noted that when the material is heated up to 250 degrees centigrade or above, carbonization of organic components of the material 50 takes place and thus it can not be used as a material for organic fertilizer any longer. Therefore, heating temperature should be less than 250 degrees centigrade, preferably 230 degrees centigrade or below.

Foul odor contained in water vapor and/or exhaust gas emitted from the device body 10 in the foregoing boiling, drying and roasting processes is drawn and discharged to the outside by the exhaust fan 7, while it is removed by the deodorizing unit 18 of a direct-fired system.

Alternatively, other deodorizing device than the deodorizing unit 18 may be used in the present invention. Also, dusts contained in the exhaust gas may be removed by the dust collector 17 provided in the preceding stage of the exhaust fan 7.

A further heating is performed by the thermal oil heater 3 for at least three hours even after the temperature reaches 160 to 170 degrees centigrade. Thereafter, the stirring blade 4 is rotated in the reverse direction, thereby discharging the products thus finished from the treatment tank 1 to the cooling hopper 13, where the products are forcedly cooled. The final products cooled to approximately normal temperature are transported to the product storage hopper 15 by the product transporting unit 14, and then they are either packed by the packing unit 16 or loaded directly into an auto truck for transportation. Alternatively, a suitable molding means may be provided on a preceding stage of the cooling hopper 13 so that the shape of the final product may be adjusted in accordance with its intended use.

The products obtained by the present embodiment takes the shape of granular particles of which the diameter is approximately in a range of from 2 to 5 mm, from which the foul odor is removed so completely that no foul odor is generated even when they get wet by being soaked in water or wet soil. Further, as the products are sterilized so completely and sanitarily, containing no moisture content therein, that they can be kept compositionally stable over a long period of time.

Furthermore, as the products can be manufactured within 24 hours, it is possible to keep costs low while enhancing manufacturing efficiencies. Specifically, whilst conventional composting methods have been affected by a lot of unstable factors in order to make the compost mature, such as a change in outside air temperature which can accelerate or delay the fermentation of the compost, the present embodiment enables easier control of temperature, so that stable quality products can be obtained, using a simple device.

The method for manufacturing an organic fertilizer using organic wastes as a raw material according to the present embodiment comprises the steps of the boiling step for boiling the organic wastes, the drying step for drying the boiled organic wastes, and the roasting step for roasting the dried organic wastes, whereby it is possible to manufacture an organic fertilizer that has excellent composition comparable to that of fully matured compost, emitting no foul odor with stable quality and composition, in a short time and at low cost, using such a simple device.

More specifically, as biological components are decomposed by boiling the organic wastes for preset hours, it is possible to manufacture an organic fertilizer that has excellent composition comparable to that of fully matured compost, emitting no foul odor all with stable quality and composition, in a short time and at low cost, using such a simple device.

Also as the boiling is carried out at 100 degrees centigrade or below for at least five hours, the decomposition of the biological components is ensured.

Furthermore, as the smelly components or ingredients are decomposed by roasting the dried organic wastes for preset hours, it is possible to manufacture an organic fertilizer that has excellent composition comparable to that of fully matured compost, emitting no foul odor at all with stable quality and composition, in a short time and at low cost, using such a simple device.

Still further, as the roasting is carried out at 160 degrees centigrade or above for at least three hours, the decomposition of the smelly components or ingredients is ensured. Particularly, the present embodiment is advantageous in that the organic wastes used as a material are either domestic animals' excrements or organic sludge, it is possible to manufacture a high quality fertilizer using most inexpensive material.

Additionally, as the moisture content adjuster such as rice chaff, sawdust or the like is used to adjust the moisture content of the organic wastes introduced in the boiling process to 85% or below, it is possible to shorten the drying time.

In addition to the foregoing, as the device for manufacturing an organic fertilizer according to the present embodiment comprises the device body 10 for boiling, drying and roasting organic wastes, the material supply means 20 for supplying the device body 10 with the organic wastes, the deodorizing means 40 for getting rid of odor or bad smell generated from the device body 10, and the product discharging means 30 for discharging products from the device body 10, it is possible to manufacture the above-featured products despite such simple structure. It should be noted that the deodorizing means 40 can prevent foul odors from coming out of the device during the manufacturing process of the fertilizer.

The present invention should not be limited to the above embodiment but various modifications are possible within the scope of the invention. For example, the organic wastes may be food wastes. Further, any suitable structure may be employed as the manufacturing device of the invention as long as it enables the implementation of the method of the invention.

Next is a description of a second embodiment of the invention, in which the present invention will be described in more detail.

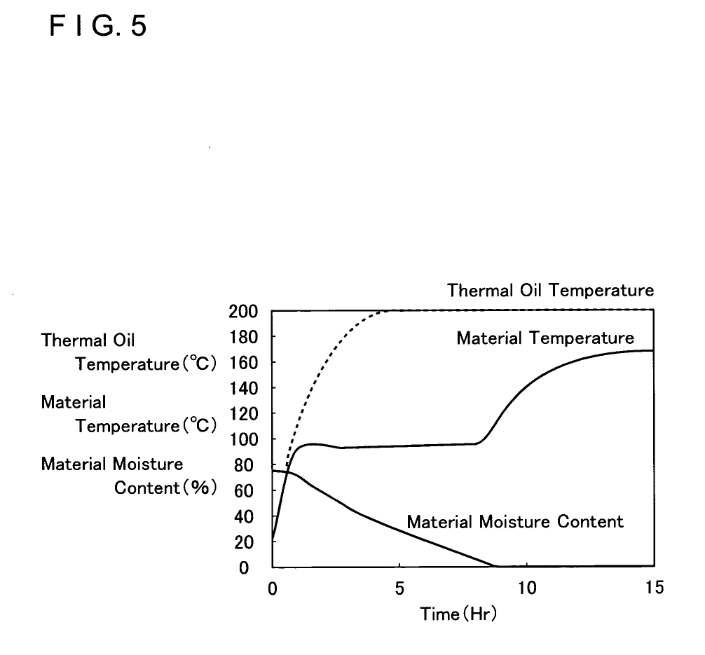

After putting 100 kg of chicken dung in the treatment tank 1, the operation of the device was started with the temperature of the jacket 2 for the thermal oil set at 200 degrees centigrade. In the boiling process, the temperature of the material 50 was at 100 degrees centigrade or below, which was then gradually increased in the drying process until the moisture content thereof was fully evaporated, which was then followed by the roasting process. In the roasting process, the smelly components such as ammonia, methylmercaptan or the like were forced out into the exhaust gas and decomposed, resulting in a sudden increase of odor level in the exhaust gas. FIG. 5 shows the change in temperature and moisture content of the material 5 and thermal oil temperature with time at this stage, while the result of componential analysis of the resultant product is shown in table 1 below.

TABLE 1

| | |
|---|---|
| moisture content | 1.4% |
| pH | 7.7 |
| total nitrogen (N) | 2.52% |
| total phosphoric acid (P₂O₅) | 10.23% |
| total potash (K₂O) | 4.06% |

While the chicken dung used as the material contained 75% moisture content, it was reduced to 25% through the drying process. Nevertheless, a sufficient amount of fertilizing components remained, and thus it was confirmed that commercial fertilizer can be produced from chicken dung. It should be noted that whilst strong odor remained in half-finished products that were taken out two hours after the evaporation started, little odor was given off from the ones which underwent the roasting process fully.

Then, germination and growth test was carried out on Japanese cruciferous vegetable called “Komatsuna” in Japanese. When the soil was mixed with the chicken dung, germination stunting was perceived when the mixing ratio thereof was 10%, while no germination perceived at 20% or more mixing ratio. In contrast, when the soil was mixed with the fertilizer obtained according to the present embodiment, better growth was perceived than when mixed with leaf mulch) and that the growth of root was found remarkably well. Further, substantially no odor was felt when the product according to the present embodiment was used.

Next is a description of a third embodiment of the invention. An organic fertilizer was manufactured respectively by using chicken dung, porcine dung and cow dung as a raw material in accordance with the method described in the first embodiment. Table 2 shows analytical values of the organic fertilizer thus obtained, conventional chicken dung compost, conventional porcine dung compost and conventional cow dung compost.

TABLE 2

| analysis items | A | B | C | D | E | F |
|---|---|---|---|---|---|---|
| total nitrogen (%) | 2.4 | 3.0 | 1.4 | 2.0 | 4.3 | 3.2 |
| total phosphoric acid (%) | 6.3 | 5.2 | 1.4 | 1.1 | 3.7 | 6.0 |
| total potash (%) | 5.9 | 3.8 | 3.2 | 1.6 | 3.5 | 2.0 |
| moisture (%) | 1.0 | 16.5 | 2.1 | 7.3 | 0.26 | 6.3 |
| organic matter (%) | 53 | 34 | 73 | — | 84 | — |
| pH(1:10H₂O 27° C.) | 7.6 | 9.1 | 7.6 | — | 6.7 | — |
| total caustic lime (%) | 21 | 4.8 | 1.6 | — | 2.2 | — |
| inorganic nitrogen (%) | 290 | 91 | 50 | — | 139 | — |
| carbon-nitrogen ratio (C/N ratio) | 11 | 6.6 | 27 | — | 10 | — |
| electrical conductivity (mS/cm) | 9.6 | 7.5 | 5.3 | — | 6.3 | — |
| organic carbon (%) | 26 | 20 | 38 | — | 43 | — |

In the above table 2, alphabetical symbols A to F mean the followings, respectively:
A: the present embodiment using chicken dung as a material
B: conventional compost using chicken dung as a material
C: the present embodiment using cow dung as a material
D: conventional compost using cow dung as a material
E: the present embodiment using porcine dung as a material
F: conventional compost using porcine dung as a material

It is to be noted that the pH of the conventional compost using chicken dung was high due to the influence of gases remaining therein, whilst that of the organic fertilizer of the present embodiment was neutral due to gases having been decomposed. Therefore, the organic fertilizer of the present embodiment showed a suitable pH value as a fertilizer.

Moreover, although the C/N (carbon to nitrogen) ratios of the organic fertilizers varied due to slight differences in composition of the respective dung, corresponding to individual differences between broilers, all the C/N ratios showed sufficiently low values, and thus the organic fertilizer of the embodiment was found suitable as a fertilizer. In the meantime, it is generally recognized that a fertilizer will ferment easily if the C/N ratio is 50 or less.

Comparison of the present embodiment with the conventional composts in respect of three major elements of fertilizers: nitrogen, phosphoric acid and potash, shows that the fertilizer of the present embodiment generally contains less nitrogen and more potash than the conventional composts, due to the decrease of nitrogen and the increase of potash caused by the thermal decomposition. As phosphoric acid has very little relationship with thermal decomposition, the phosphoric acid value of the conventional one is substantially the same as that of the present embodiment.

Still also, a suitable value for the fertilizer was obtained concerning electrical conductivity as well.

Next, germination and growth test was carried out on Japanese cruciferous vegetable “Komatsuna”, using these organic fertilizers. For comparative examples were used chicken dung compost, porcine dung compost and cow dung compost which are on the market as commercial fertilizers.

Three types of organic fertilizers of the invention manufactured by using chicken dung, porcine dung and cow dung as a raw material as well as the above-mentioned three types of general composts were added to the soil in a proportion of 10%, respectively. Then, the seeds of Komatsuna were sowed in the respective soils. Germination was observed five days after the sowing not only in the soils to which were added organic fertilizers of the present invention but also in the soils to which were added the general composts. Both indicated 80% or more germination rates.

Table 3 shows how high the respective Komatsuna grew twenty-one days after the sowing.

TABLE 3

| Measurement items | A | B | C | D | E | F |
|---|---|---|---|---|---|---|
| length (cm) | 7 | 6 | 6 | 5 | 6.5 | 5.5 |

Herein, alphabetical symbols A to F mean the same as those of Table 2.

As shown in Table 3, better results were obtained when the organic fertilizers of the invention were used than when the conventional general composts were used. Further, leaves had deeper green colors and the live weights of aerial parts were heavier when the organic fertilizers of the invention were used. Thus, it could be acknowledged that the organic fertilizer of the present invention has such an advantageous effect that can compare favorably with fully matured compost.

Next is a description of a fourth embodiment of the invention. An organic fertilizer was manufactured by using chicken dung as a raw material in accordance with the invention, which was then used as a subject for Komatsuna's embryonic-stage growth test, to see how the resultant fertilizer affected the germination and post-germination growth thereof.

A first sample was prepared by adding a standard amount of the fertilizer of the invention to 500 ml soil, said standard amount being defined as an amount of the fertilizer that contains 100 mg nitrogen content therein. Then, second to fourth samples were prepared respectively by adding twice, three and four times the standard amount of the fertilizer of the invention to 500 ml soil. Besides, a comparative example without adding the fertilizer of the invention was prepared for comparison purpose. Then, to these first to fourth samples and the comparative sample were added 25 mg nitrogen (N), 25 mg phosphoric acid (P₂O₅) and 25 mg potash (K₂O) by adding a commercial compound fertilizer (8-8-8), and they were mixed well.

These sample soils were then filled in a pot of 500 ml volume respectively, and 20 seeds of Komatsuna were sowed in each pot. Then, germination rate on the 10th day of the sowing, growth length on the 25th day of the sowing, leaf colors and live weight of aerial parts were measured respectively. Table 4 shows measurement results, each showing an average value obtained from two pots of the same sample. Leaf colors were measured by SPAD-502 (MINOLTA, registered trademark). Greater measurement value of leaf color indicates a deeper leaf color,

TABLE 4

| | | | | | live weight of |
|---|---|---|---|---|---|
| applied | | germination | length | Leaf colors | aerial part |
| amount | | rate (%) | (cm) | (spad value) | (g/pot) |
| standard | mean | 85 | 8.7 | 29.1 | 11.3 |
| | index | | 99 | | 107 |
| double | mean | 80 | 8.9 | 27.0 | 12.1 |
| | index | | 101 | | 114 |
| triple | mean | 73 | 9.2 | 27.1 | 11.7 |
| | index | | 105 | | 110 |
| quadruple | mean | 90 | 9.1 | 27.6 | 13.6 |
| | index | | 103 | | 128 |
| none | mean | 88 | 8.8 | 27.4 | 10.6 |
| | index | | 100 | | 100 |

As shown in Table 4, the germination test performed 10 days after the sowing indicated that the germination rates of the first (standard), second (double), fourth (quadruple) and fifth (none) samples were 80% or more, showing no problems. From this germination test, it is presumed that immature components contained in chicken dung that could cause disturbance of growth were decomposed completely during the manufacturing processes of the fertilizer of the invention.

25 days after the sowing, there could also be seen an advantageous tendency that the Komatsuna grown in the pots which were fertilized with the fertilizer of the invention had a greater live weight of aerial part than that grown in the pots which were not fertilized therewith. On the other hand, there could be seen no substantial difference in growth length and leaf color between the former and the latter. This growth test well demonstrates that the organic fertilizer of the invention can be used as a substitute for chemical or compound fertilizer, having such an excellent effect that can favorably compare with fully matured compost.

What is claimed:

1. A method for manufacturing an organic fertilizer using organic wastes as a raw material, which comprises the steps of:
boiling the organic wastes;
drying the boiled organic wastes; and
roasting the dried organic wastes.

2. A method for manufacturing an organic fertilizer according to claim 1, wherein said organic wastes are boiled for preset hours so as to decompose organic components thereof in said boiling step.

3. A method for manufacturing an organic fertilizer according to claim 2, wherein boiling is carried out for at least five hours at less than 100 degrees centigrade in said boiling step.

4. A method for manufacturing an organic fertilizer according to claim 1, wherein said dried organic wastes are roasted for preset hours so as to decompose smelly components in said roasting process.

5. A method for manufacturing an organic fertilizer according to claim 4, wherein roasting is carried out for at least three hours in a range from 160 degrees centigrade to 230 degrees centigrade.

6. A method for manufacturing an organic fertilizer according to claim 1, wherein said organic wastes are either domestic animals' excrements or organic sludge.

7. A method for manufacturing an organic fertilizer according to claim 6, wherein said organic wastes used in said boiling step have moisture content reduced to 85% or below by using a moisture adjuster.

8. A device for manufacturing an organic fertilizer using organic wastes as a raw material, comprising:
a device body for boiling, drying and roasting organic wastes;
a material supply means for supplying said device body with said organic wastes;
a deodorizing means for getting rid of bad smell generated from said device body, and
a product discharge means for discharging final products from said device body.

9. A device for manufacturing an organic fertilizer according to claim 8, wherein said organic wastes are either domestic animals' excrements or organic sludge.
